(19) United States
(12) Patent Application Publication
(10) Pub. No.: US 2024/0314715 A1
(43) Pub. Date: Sep. 19, 2024

(54) METHOD AND APPARATUS FOR COMMUNICATION NETWORK COMPRISING NETWORK SLICES

(71) Applicant: Nokia Technologies Oy, Espoo (FI)

(72) Inventor: Alessio CASATI, West Molesey (GB)

(21) Appl. No.: 18/575,529

(22) PCT Filed: Jul. 8, 2021
(86) PCT No.: PCT/EP2021/069081

§ 371 Date: Dec. 29, 2023

(51) Int. Cl. H04W 60/00; H04W 76/10

(52) U.S. Cl. CPC H04W 60/005; H04W 76/10

(57) ABSTRACT

A technique comprising: receiving, at a user equipment, parallel registration information indicating at least: one or more first network slices associated with a first access management function instance; and one or more second network slices associated with a second access management function instance and registrable in parallel with the one or more first network slices.

### TECHNICAL FIELD

The present disclosure relates to apparatus, a method, and a computer program, and in particular to apparatus, methods and computer programs for communication networks comprising network slices.

### BACKGROUND

Some communication networks divide their network resources into network slices with a possibility for a high degree of isolation between network slices. The division of network resources may include, for example, the division of access management functions between a plurality of access management function instances.

### SUMMARY

A method comprising: receiving, at a user equipment, parallel registration information indicating at least: one or more first network slices associated with a first access management function instance; and one or more second network slices associated with a second access management function instance and registrable in parallel with the one or more first network slices.

The method may further comprise receiving the parallel registration information after transmitting, from the user equipment, an indication of support at the user equipment for parallel registration to a plurality of network slices associated with a plurality of access management function instances.

The method may further comprise: including the indication in a registration request message inside a radio resource control (RRC) connection setup complete message of a procedure to set up a first RRC connection; and receiving the parallel registration information in a registration accept message from an access management function instance in response to the registration request message.

The parallel registration information may comprise at least a first network slice group value for the first one or more network slices; and at least a second network slice group value for the one or more second network slices.

The method may comprise: establishing a second RRC connection in parallel with the first RRC connection, wherein establishing the second RRC connection comprises: transmitting, inside a RRC connection setup complete message specifying the first network slice group value, a registration request message specifying one or more network slices mapped to the first network slice group value.

The method may comprise: establishing a third RRC connection in parallel with at least the second RRC connection, wherein establishing the third RRC connection comprises: transmitting, inside a RRC connection setup complete message specifying the second network slice group value, a RRC connection setup complete message including a registration request message specifying one or more network slices mapped to the second network slice group value.

The parallel registration information may indicate at least: a first group of network slices associated with a first access management function instance and registrable in parallel with each other; and a second group of network slices associated with a second access management function instance, wherein the network slices of the second group are registrable in parallel with each other and in parallel with any network slice of the first group.

The parallel registration information may indicate the at least one or more first network slices and the one or more second network slices, without reference to groups of network slices registrable in parallel with each other via a common access management function instance.

The registration request message may comprise at least: an indication of one or more requested network slices.

The registration request message may further comprise at least: an indication of one or more network slices to which the user equipment is already registered, and one or more network slice group values for the one or more network slices to which the user equipment is already registered.

The parallel registration information may selectively comprise an indication of one or more network slices registrable in parallel to the one or more network slices to which the user equipment is already registered.

A method comprising: directing, from an access management function instance to a user equipment, parallel registration information indicating at least: one or more first network slices associated with a first access management function instance; and one or more second network slices associated with a second access management function instance and registrable in parallel with the one or more first network slices.

The method may further comprise: directing the parallel registration information to the user equipment after receiving an indication of support at the user equipment for parallel registration to a plurality of network slices associated with a plurality of access management function instances.

The method may further comprise: receiving the indication at the access management function instance in a registration request message; and directing the parallel registration information from the access management function instance to the user equipment in a registration accept message in response to the registration request message.

The parallel registration information may comprise at least a first network slice group value for the first one or more network slices instances; and at least a second network slice group value for the one or more second network slices instances.

The parallel registration information may indicate at least: a first group of network slices associated with a first access management function instance and registrable in parallel with each other; and a second group of network slices associated with a second access management function instance, wherein the network slices of the second group are registrable in parallel with each other and in parallel with any network slice of the first group.

The parallel registration information may indicate the at least one or more first network slices and the one or more second network slices, without reference to groups of network slices registrable in parallel with each other via a common access management function instance.

The registration request message may comprise at least: an indication of one or more requested network slices.

The registration request message may further comprise at least: an indication of one or more network slices to which the user equipment is already registered; and one or more network slice group values for the one or more network slices to which the user equipment is already registered.

The parallel registration information may selectively comprise an indication of one or more network slices registrable in parallel to the one or more network slices to which the user equipment is already registered.

A method comprising: in response to receiving, at a radio access network node, a RRC connection setup complete message carrying a registration request message, selecting an access management function instance to which to forward the registration request message based on a network slice group identifier value included in the connection setup complete message.

A method comprising: storing, at a unified data management function, information about a user equipment, wherein the information maps the user equipment to a plurality of access management functions for a plurality of network slice groups.

The method may comprise storing, at the unified data management function, a plurality of subscription identifiers for the user equipment for a plurality of network slice groups.

Apparatus comprising: means for receiving, parallel registration information indicating at least: one or more first network slices associated with a first access management function instance; and one or more second network slices associated with a second access management function instance and registrable in parallel with the one or more first network slices.

The apparatus may further comprise means for receiving the parallel registration information after transmitting, an indication of support at a user equipment for parallel registration to a plurality of network slices associated with a plurality of access management function instances.

The apparatus may further comprise: means for including the indication in a registration request message inside a RRC connection setup complete message of a procedure to set up a first RRC connection; and means for receiving the parallel registration information in a registration accept message from an access management function instance in response to the registration request message.

The parallel registration information may comprise: at least a first network slice group value for the first one or more network slices; and at least a second network slice group value for the one or more second network slices.

The apparatus may comprise: means for establishing a second RRC connection in parallel with the first RRC connection, wherein the means for establishing the second RRC connection may comprise means for transmitting, inside a RRC connection setup complete message specifying the first network slice group value, a registration request message specifying one or more network slices mapped to the first network slice group value.

The apparatus may comprise: means for establishing a third RRC connection in parallel with at least the second RRC connection, wherein the means for establishing the third RRC connection may comprise means for transmitting, inside a RRC connection setup complete message specifying the second network slice group value, a RRC connection setup complete message including a registration request message specifying one or more network slices mapped to the second network slice group value.

The parallel registration information may indicate at least: a first group of network slices associated with a first access management function instance and registrable in parallel with each other; and a second group of network slices associated with a second access management function instance, wherein the network slices of the second group are registrable in parallel with each other and in parallel with any network slice of the first group.

The parallel registration information may indicate the at least one or more first network slices and the one or more second network slices, without reference to groups of network slices registrable in parallel with each other via a common access management function instance.

The registration request message may comprise at least: an indication of one or more requested network slices.

The registration request message may further comprise at least: an indication of one or more network slices to which the user equipment is already registered, and one or more network slice group values for the one or more network slices to which the user equipment is already registered.

The parallel registration information may selectively comprise an indication of one or more network slices registrable in parallel to the one or more network slices to which the user equipment is already registered.

Apparatus, comprising: means for directing, to a user equipment, parallel registration information indicating at least: one or more first network slices associated with a first access management function instance; and one or more second network slices associated with a second access management function instance and registrable in parallel with the one or more first network slices.

The apparatus may further comprise: means for directing the parallel registration information to the user equipment after receiving an indication of support at the user equipment for parallel registration to a plurality of network slices associated with a plurality of access management function instances.

The apparatus may further comprise: means for receiving the indication in a registration request message; and means for directing the parallel registration information to the user equipment in a registration accept message in response to the registration request message.

The parallel registration information may comprise at least a first network slice group value for the first one or more network slices instances; and at least a second network slice group value for the one or more second network slices instances.

The parallel registration information may indicate at least: a first group of network slices associated with a first access management function instance and registrable in parallel with each other; and a second group of network slices associated with a second access management function instance, wherein the network slices of the second group are registrable in parallel with each other and in parallel with any network slice of the first group.

The parallel registration information may indicate the at least one or more first network slices and the one or more second network slices, without reference to groups of network slices registrable in parallel with each other via a common access management function instance.

The registration request message may comprise at least: an indication of one or more requested network slices.

The registration request message may further comprise at least: an indication of one or more network slices to which the user equipment is already registered; and one or more network slice group values for the one or more network slices to which the user equipment is already registered.

The parallel registration information may selectively comprise an indication of one or more network slices registrable in parallel to the one or more network slices to which the user equipment is already registered.

Apparatus comprising: means for, in response to receiving a RRC connection setup complete message carrying a registration request message, selecting an access management function instance to which to forward the registration request message based on a network slice group identifier value included in the connection setup complete message.

Apparatus comprising: means for storing information about a user equipment, wherein the information maps the user equipment to a plurality of access management functions for a plurality of network slice groups.

The apparatus may comprise means for storing a plurality of subscription identifiers for the user equipment for a plurality of network slice groups.

An apparatus comprising: at least one processor; and at least one memory including computer program code, the at least one memory and computer program code configured to, with the at least one processor, cause the apparatus to perform: receiving parallel registration information indicating at least: one or more first network slices associated with a first access management function instance; and one or more second network slices associated with a second access management function instance and registrable in parallel with the one or more first network slices.

The at least one memory and computer program code may be configured to, with the at least one processor, cause the apparatus to: receive the parallel registration information after transmitting an indication of support at a user equipment for parallel registration to a plurality of network slices associated with a plurality of access management function instances.

The at least one memory and computer program code may be configured to, with the at least one processor, cause the apparatus to: include the indication in a registration request message inside a RRC connection setup complete message of a procedure to set up a first RRC connection; and receive the parallel registration information in a registration accept message from an access management function instance in response to the registration request message.

The parallel registration information may comprise at least a first network slice group value for the first one or more network slices; and at least a second network slice group value for the one or more second network slices.

The at least one memory and computer program code may be configured to, with the at least one processor, cause the apparatus to: establish a second RRC connection in parallel with the first RRC connection, wherein establishing the second RRC connection comprises: transmitting, inside a RRC connection setup complete message specifying the first network slice group value, a registration request message specifying one or more network slices mapped to the first network slice group value.

The at least one memory and computer program code may be configured to, with the at least one processor, cause the apparatus to: establish a third RRC connection in parallel with at least the second RRC connection, wherein establishing the third RRC connection comprises: transmitting, inside a RRC connection setup complete message specifying the second network slice group value, a RRC connection setup complete message including a registration request message specifying one or more network slices mapped to the second network slice group value.

The parallel registration information may indicate at least: a first group of network slices associated with a first access management function instance and registrable in parallel with each other; and a second group of network slices associated with a second access management function instance, wherein the network slices of the second group are registrable in parallel with each other and in parallel with any network slice of the first group.

The parallel registration information may indicate the at least one or more first network slices and the one or more second network slices, without reference to groups of network slices registrable in parallel with each other via a common access management function instance.

The registration request message may comprise at least: an indication of one or more requested network slices.

The registration request message may further comprise at least: an indication of one or more network slices to which the user equipment is already registered, and one or more network slice group values for the one or more network slices to which the user equipment is already registered.

The parallel registration information may selectively comprise an indication of one or more network slices registrable in parallel to the one or more network slices to which the user equipment is already registered.

An apparatus comprising: at least one processor; and at least one memory including computer program code, the at least one memory and computer program code configured to, with the at least one processor, cause the apparatus to perform: directing, to a user equipment, parallel registration information indicating at least: one or more first network slices associated with a first access management function instance; and one or more second network slices associated with a second access management function instance and registrable in parallel with the one or more first network slices.

The at least one memory and computer program code may be configured to, with the at least one processor, cause the apparatus to: direct the parallel registration information to the user equipment after receiving an indication of support at the user equipment for parallel registration to a plurality of network slices associated with a plurality of access management function instances.

The at least one memory and computer program code may be configured to, with the at least one processor, cause the apparatus to: receive the indication in a registration request message; and direct the parallel registration information to the user equipment in a registration accept message in response to the registration request message.

The parallel registration information may comprise at least a first network slice group value for the first one or more network slices instances; and at least a second network slice group value for the one or more second network slices instances.

The parallel registration information may indicate at least: a first group of network slices associated with a first access management function instance and registrable in parallel with each other; and a second group of network slices associated with a second access management function instance, wherein the network slices of the second group are registrable in parallel with each other and in parallel with any network slice of the first group.

The parallel registration information may indicate the at least one or more first network slices and the one or more second network slices, without reference to groups of network slices registrable in parallel with each other via a common access management function instance.

The registration request message may comprise at least: an indication of one or more requested network slices.

The registration request message may further comprise at least: an indication of one or more network slices to which the user equipment is already registered; and one or more network slice group values for the one or more network slices to which the user equipment is already registered.

The parallel registration information may selectively comprise an indication of one or more network slices registrable in parallel to the one or more network slices to which the user equipment is already registered.

An apparatus comprising: at least one processor; and at least one memory including computer program code, the at least one memory and computer program code configured to, with the at least one processor, cause the apparatus to perform: in response to receiving a RRC connection setup complete message carrying a registration request message, selecting an access management function instance to which to forward the registration request message based on a network slice group identifier value included in the connection setup complete message.

An apparatus comprising: at least one processor; and at least one memory including computer program code, the at least one memory and computer program code configured to, with the at least one processor, cause the apparatus to perform: storing information about a user equipment, wherein the information maps the user equipment to a plurality of access management functions for a plurality of network slice groups.

The at least one memory and computer program code may be configured to, with the at least one processor, cause the apparatus to store a plurality of subscription identifiers for the user equipment for a plurality of network slice groups.

Apparatus comprising: receiving circuitry for receiving parallel registration information indicating at least: one or more first network slices associated with a first access management function instance; and one or more second network slices associated with a second access management function instance and registrable in parallel with the one or more first network slices.

Apparatus, comprising: directing circuitry for directing, to a user equipment, parallel registration information indicating at least: one or more first network slices associated with a first access management function instance; and one or more second network slices associated with a second access management function instance and registrable in parallel with the one or more first network slices.

Apparatus comprising: selecting circuitry for, in response to receiving a RRC connection setup complete message carrying a registration request message, selecting an access management function instance to which to forward the registration request message based on a network slice group identifier value included in the connection setup complete message.

Apparatus comprising: storing circuitry for storing information about a user equipment, wherein the information maps the user equipment to a plurality of access management functions for a plurality of network slice groups.

A computer readable medium comprising program instructions stored thereon for performing: receiving parallel registration information indicating at least: one or more first network slices associated with a first access management function instance; and one or more second network slices associated with a second access management function instance and registrable in parallel with the one or more first network slices.

A computer readable medium comprising program instructions stored thereon for performing: directing, to a user equipment, parallel registration information indicating at least: one or more first network slices associated with a first access management function instance; and one or more second network slices associated with a second access management function instance and registrable in parallel with the one or more first network slices.

A computer readable medium comprising program instructions stored thereon for performing: in response to receiving a RRC connection setup complete message carrying a registration request message, selecting an access management function instance to which to forward the registration request message based on a network slice group identifier value included in the connection setup complete message.

A computer readable medium comprising program instructions stored thereon for performing: storing information about a user equipment, wherein the information maps the user equipment to a plurality of access management functions for a plurality of network slice groups.

A computer program comprising computer executable code which when run on at least one processor is configured to cause an apparatus at least to: receive parallel registration information indicating at least: one or more first network slices associated with a first access management function instance; and one or more second network slices associated with a second access management function instance and registrable in parallel with the one or more first network slices.

A computer program comprising computer executable code which when run on at least one processor is configured to cause an apparatus at least to: direct, to a user equipment, parallel registration information indicating at least: one or more first network slices associated with a first access management function instance; and one or more second network slices associated with a second access management function instance and registrable in parallel with the one or more first network slices.

A computer program comprising computer executable code which when run on at least one processor is configured to cause an apparatus at least to: in response to receiving a RRC connection setup complete message carrying a registration request message, select an access management function instance to which to forward the registration request message based on a network slice group identifier value included in the connection setup complete message.

A computer program comprising computer executable code which when run on at least one processor is configured to cause an apparatus at least to: store information about a user equipment, wherein the information maps the user equipment to a plurality of access management functions for a plurality of network slice groups.

A non-transitory computer readable medium comprising program instructions stored thereon for performing: receiving parallel registration information indicating at least: one or more first network slices associated with a first access management function instance; and one or more second network slices associated with a second access management function instance and registrable in parallel with the one or more first network slices.

A non-transitory computer readable medium comprising program instructions stored thereon for performing: directing, to a user equipment, parallel registration information indicating at least: one or more first network slices associated with a first access management function instance; and one or more second network slices associated with a second access management function instance and registrable in parallel with the one or more first network slices.

A non-transitory computer readable medium comprising program instructions stored thereon for performing: in response to receiving a RRC connection setup complete message carrying a registration request message, selecting an access management function instance to which to forward the registration request message based on a network slice group identifier value included in the connection setup complete message.

A non-transitory computer readable medium comprising program instructions stored thereon for performing: storing information about a user equipment, wherein the information maps the user equipment to a plurality of access management functions for a plurality of network slice groups.

In the above, many different aspects have been described. It should be appreciated that further aspects may be provided by the combination of any two or more of the aspects described above.

Various other aspects are also described in the following detailed description and in the attached claims.

### BRIEF DESCRIPTION OF THE FIGURES

Some example embodiments will now be described in further detail, by way of example only, with reference to the following examples and accompanying drawings, in which:

FIG. 1 illustrates an example system to which embodiments may be applied;

FIG. 2 shows a representation of a radio access network (RAN) of a 5G system having control plane interfaces to a plurality of access management function instances of a core network of the 5G system, according to some example embodiments;

FIGS. 3a and 3b show a representation of an example of operations at a user equipment, a RAN, a plurality of access management function instances and a unified data management function according to a first example embodiment;

FIGS. 4a and 4b show a representation of an example of operations at a user equipment, a RAN, a plurality of access management function instances and a unified data management function according to a second example embodiment;

FIGS. 5a and 5b show a representation of an example of operations at a user equipment, a RAN, a plurality of access management function instances and a unified data management function according to a third example embodiment;

FIG. 6 shows a representation of an example of data stored at a unified data management function according to some example embodiments;

FIG. 7 shows a representation of an example of apparatus for implementing operations at a user equipment or RAN node according to some example embodiments;

FIG. 8 shows a representation of an example of apparatus for implementing operations at a core network node according to some example embodiments; and

FIG. 9 shows a representation of an example of non-volatile memory media.

### DETAILED DESCRIPTION

The following description of example embodiments makes mention of systems (user equipments, RAN nodes, core network nodes) operating according to specific 3GPP protocols (e.g. 5G protocol), but the underlying technique is also applicable to systems operating according to other protocols, such as more evolved 3GPP protocols.

The term “user equipment” here refers to any device, apparatus or component implementing user equipment functionality; and may include, for example, vehicles or other machinery implementing UE functionality.

In the following, different exemplifying embodiments will be described using, as an example of an access architecture to which the embodiments may be applied, a radio access architecture based on long term evolution advanced (LTE Advanced, LTE-A) or new radio (NR, 5G), without restricting the embodiments to such an architecture, however. The embodiments may also be applied to other kinds of communications networks having suitable means by adjusting parameters and procedures appropriately. Some examples of other options for suitable systems are the universal mobile telecommunications system (UMTS) radio access network (UTRAN), wireless local area network (WLAN or WiFi), worldwide interoperability for microwave access (WiMAX), Bluetooth®, personal communications services (PCS), ZigBee®, wideband code division multiple access (WCDMA), systems using ultra-wideband (UWB) technology, sensor networks, mobile ad-hoc networks (MANETs) and Internet Protocol multimedia subsystems (IMS) or any combination thereof.

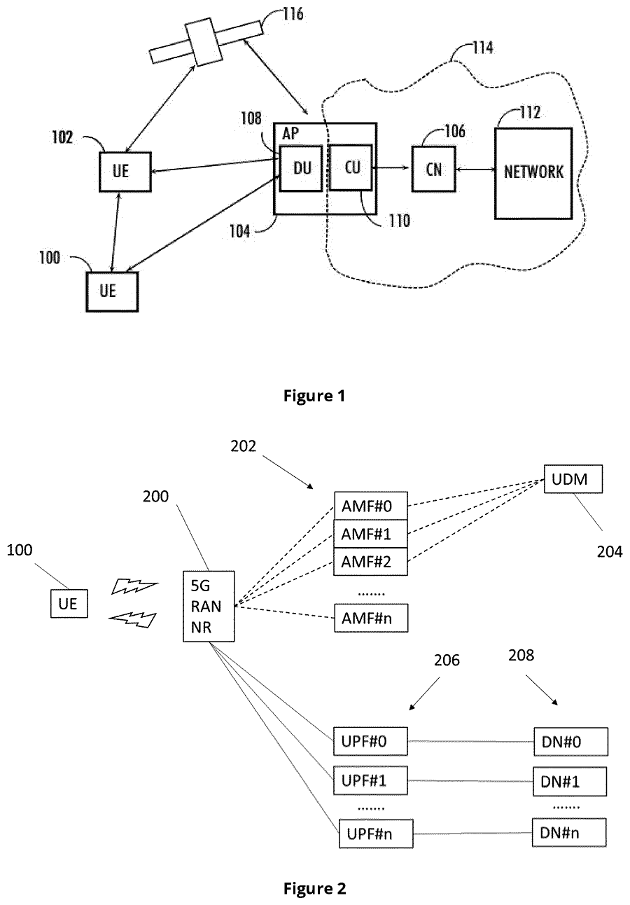

FIG. 1 depicts examples of simplified system architectures only showing some elements and functional entities, all being logical units, whose implementation may differ from what is shown. The connections shown in FIG. 1 are logical connections; the actual physical connections may be different. It is apparent to a person skilled in the art that the system typically comprises also other functions and structures than those shown in FIG. 1.

The embodiments are not, however, restricted to the system given as an example but a person skilled in the art may apply the solution to other communication systems provided with necessary properties.

The example of FIG. 1 shows a part of an exemplifying radio access network. For example, the radio access network may support sidelink communications described below in more detail.

FIG. 1 shows devices 100 and 102. The devices 100 and 102 are configured to be in a wireless connection on one or more communication channels with a node 104. The node 104 is further connected to a core network 106. In one example, the node 104 may be an access node such as (e/g)NodeB serving devices in a cell. In one example, the node 104 may be a non-3GPP access node. The physical link from a device to a (e/g)NodeB is called uplink or reverse link and the physical link from the (e/g)NodeB to the device is called downlink or forward link. It should be appreciated that (e/g)NodeBs or their functionalities may be implemented by using any node, host, server or access point etc. entity suitable for such a usage.

A communications system typically comprises more than one (e/g)NodeB in which case the (e/g)NodeBs may also be configured to communicate with one another over links, wired or wireless, designed for the purpose. These links may be used for signalling purposes. The (e/g)NodeB is a computing device configured to control the radio resources of communication system it is coupled to. The NodeB may also be referred to as a base station, an access point or any other type of interfacing device including a relay station capable of operating in a wireless environment. The (e/g)NodeB includes or is coupled to transceivers. From the transceivers of the (e/g)NodeB, a connection is provided to an antenna unit that establishes bi-directional radio links to devices. The antenna unit may comprise a plurality of antennas or antenna elements. The (e/g)NodeB is further connected to the core network 106 (CN or next generation core NGC). Depending on the deployed technology, the (e/g)NodeB is connected to a serving and packet data network gateway (S-GW+P-GW) or user plane function (UPF), for routing and forwarding user data packets and for providing connectivity of devices to one or more external packet data networks, and to a mobile management entity (MME) or access mobility management function (AMF), for controlling access and mobility of the devices.

Exemplary embodiments of a device are a subscriber unit, a user device, a user equipment (UE), a user terminal, a terminal device, a mobile station, a mobile device, etc

The device typically refers to a mobile or static device (e.g. a portable or non-portable computing device) that includes wireless mobile communication devices operating with or without an universal subscriber identification module (USIM), including, but not limited to, the following types of devices: mobile phone, smartphone, personal digital assistant (PDA), handset, device using a wireless modem (alarm or measurement device, etc.), laptop and/or touch screen computer, tablet, game console, notebook, and multimedia device. It should be appreciated that a device may also be a nearly exclusive uplink only device, of which an example is a camera or video camera loading images or video clips to a network. A device may also be a device having capability to operate in Internet of Things (IoT) network which is a scenario in which objects are provided with the ability to transfer data over a network without requiring human-to-human or human-to-computer interaction, e.g. to be used in smart power grids and connected vehicles. The device may also utilise cloud. In some applications, a device may comprise a user portable device with radio parts (such as a watch, earphones or eyeglasses) and the computation is carried out in the cloud.

The device illustrates one type of an apparatus to which resources on the air interface are allocated and assigned, and thus any feature described herein with a device may be implemented with a corresponding apparatus, such as a relay node. An example of such a relay node is a layer 3 relay (self-backhauling relay) towards the base station. The device (or in some embodiments a layer 3 relay node) is configured to perform one or more of user equipment functionalities.

Various techniques described herein may also be applied to a cyber-physical system (CPS) (a system of collaborating computational elements controlling physical entities). CPS may enable the implementation and exploitation of massive amounts of interconnected information and communications technology, ICT, devices (sensors, actuators, processors microcontrollers, etc.) embedded in physical objects at different locations. Mobile cyber physical systems, in which the physical system in question has inherent mobility, are a subcategory of cyber-physical systems. Examples of mobile physical systems include mobile robotics and electronics transported by humans or animals.

Additionally, although the apparatuses have been depicted as single entities, different units, processors and/or memory units (not all shown in FIG. 1) may be implemented.

5G enables using multiple input-multiple output (MIMO) antennas, many more base stations or nodes than the LTE (a so-called small cell concept), including macro sites operating in co-operation with smaller stations and employing a variety of radio technologies depending on service needs, use cases and/or spectrum available. 5G mobile communications supports a wide range of use cases and related applications including video streaming, augmented reality, different ways of data sharing and various forms of machine type applications (such as (massive) machine-type communications (mMTC), including vehicular safety, different sensors and real-time control). 5G is expected to have multiple radio interfaces, e.g. below 6 GHz or above 24 GHz, cmWave and mmWave, and also being integrable with existing legacy radio access technologies, such as the LTE. Integration with the LTE may be implemented, at least in the early phase, as a system, where macro coverage is provided by the LTE and 5G radio interface access comes from small cells by aggregation to the LTE. In other words, 5G is planned to support both inter-RAT operability (such as LTE-5G) and inter-RI operability (inter-radio interface operability, such as below 6 GHZ-cmWave, 6 or above 24 GHZ-cmWave and mmWave). One of the concepts considered to be used in 5G networks is network slicing in which multiple independent and dedicated virtual sub-networks (network instances) may be created within the same infrastructure to run services that have different requirements on latency, reliability, throughput and mobility.

The current architecture in LTE networks is fully distributed in the radio and fully centralized in the core network. The low latency applications and services in 5G require to bring the content close to the radio which leads to local break out and multi-access edge computing (MEC). 5G enables analytics and knowledge generation to occur at the source of the data. This approach requires leveraging resources that may not be continuously connected to a network such as laptops, smartphones, tablets and sensors. MEC provides a distributed computing environment for application and service hosting. It also has the ability to store and process content in close proximity to cellular subscribers for faster response time. Edge computing covers a wide range of technologies such as wireless sensor networks, mobile data acquisition, mobile signature analysis, cooperative distributed peer-to-peer ad hoc networking and processing also classifiable as local cloud/fog computing and grid/mesh computing, dew computing, mobile edge computing, cloudlet, distributed data storage and retrieval, autonomic self-healing networks, remote cloud services, augmented and virtual reality, data caching, Internet of Things (massive connectivity and/or latency critical), critical communications (autonomous vehicles, traffic safety, real-time analytics, time-critical control, healthcare applications).

The communication system is also able to communicate with other networks 112, such as a public switched telephone network, or a VoIP network, or the Internet, or a private network, or utilize services provided by them. The communication network may also be able to support the usage of cloud services, for example at least part of core network operations may be carried out as a cloud service (this is depicted in FIG. 1 by “cloud” 114). The communication system may also comprise a central control entity, or a like, providing facilities for networks of different operators to cooperate for example in spectrum sharing.

The technology of Edge cloud may be brought into a radio access network (RAN) by utilizing network function virtualization (NFV) and software defined networking (SDN). Using the technology of edge cloud may mean access node operations to be carried out, at least partly, in a server, host or node operationally coupled to a remote radio head or base station comprising radio parts. It is also possible that node operations will be distributed among a plurality of servers, nodes or hosts. Application of cloudRAN architecture enables RAN real time functions being carried out at or close to a remote antenna site (in a distributed unit, DU 108) and non-real time functions being carried out in a centralized manner (in a centralized unit, CU 110).

It should also be understood that the distribution of labour between core network operations and base station operations may differ from that of the LTE or even be non-existent. Some other technology advancements probably to be used are Big Data and all-IP, which may change the way networks are being constructed and managed. 5G (or new radio, NR) networks are being designed to support multiple hierarchies, where MEC servers can be placed between the core and the base station or nodeB (gNB). It should be appreciated that MEC can be applied in 4G networks as well.

5G may also utilize satellite communication to enhance or complement the coverage of 5G service, for example by providing backhauling. Possible use cases are providing service continuity for machine-to-machine (M2M) or Internet of Things (IoT) devices or for passengers on board of vehicles, Mobile Broadband, (MBB) or ensuring service availability for critical communications, and future railway/maritime/aeronautical communications. Satellite communication may utilise geostationary earth orbit (GEO) satellite systems, but also low earth orbit (LEO) satellite systems, in particular mega-constellations (systems in which hundreds of (nano)satellites are deployed). Each satellite in the mega-constellation may cover several satellite-enabled network entities that create on-ground cells. The on-ground cells may be created through an on-ground relay node or by a gNB located on-ground or in a satellite.

It is clear to a person skilled in the art that the depicted system is only an example of a part of a radio access system and in practice, the system may comprise a plurality of (e/g)NodeBs, the device may have an access to a plurality of radio cells and the system may comprise also other apparatuses, such as physical layer relay nodes or other network elements, etc. At least one of the (e/g)NodeBs or may be a Home(e/g)nodeB. Additionally, in a geographical area of a radio communication system a plurality of different kinds of radio cells as well as a plurality of radio cells may be provided. Radio cells may be macro cells (or umbrella cells) which are large cells, usually having a diameter of up to tens of kilometers, or smaller cells such as micro-, femto- or picocells. The (e/g)NodeBs of FIG. 1 may provide any kind of these cells. A cellular radio system may be implemented as a multilayer network including several kinds of cells. Typically, in multilayer networks, one access node provides one kind of a cell or cells, and thus a plurality of (e/g)NodeBs are required to provide such a network structure.

For fulfilling the need for improving the deployment and performance of communication systems, the concept of “plug-and-play” (e/g)NodeBs has been introduced. Typically, a network which is able to use “plug-and-play” (e/g)Node Bs, includes, in addition to Home (e/g)NodeBs (H(e/g)nodeBs), a home node B gateway, or HNB-GW (not shown in FIG. 1). A HNB Gateway (HNB-GW), which is typically installed within an operator's network may aggregate traffic from a large number of HNBs back to a core network.

FIG. 2 shows a representation of some components of a 5G system according to some example embodiments. At least some resources of the 5G system are divided into network slices identified by single network slice selection assistance identifiers (S-NSSAIs), with the possibility of a high degree of isolation between network slices. The division of resources may include the division of access management functionality among a plurality of access and mobility management function instances (AMF instances) 204. In these example embodiments, each AMF instance 204 is associated with a respective group of one or more network slices, at least for some user equipments. The AMF instances 204 may or may not be implemented at the same location.

The 5G system shown in FIG. 2 also includes a unified data management (UDM) function 206. Each AMF instance 204 may communicate with the UDM function 206 for e.g. (a) UE authentication etc. for UEs for which the AMF instance 204 receives a registration request, and (b) registration at the UDM function 206 of the AMF instance as a currently serving AMF for the UE.

FIG. 2 also shows some user plane functions (UPFs) 208. Each UPF 208 acts as a packet data gateway to a data network (DN) 210. FIG. 2 shows each UPF acting as a packet data gateway to a respective DN 210, but one or more DNs 210 may be associated with more than one UPF 208.

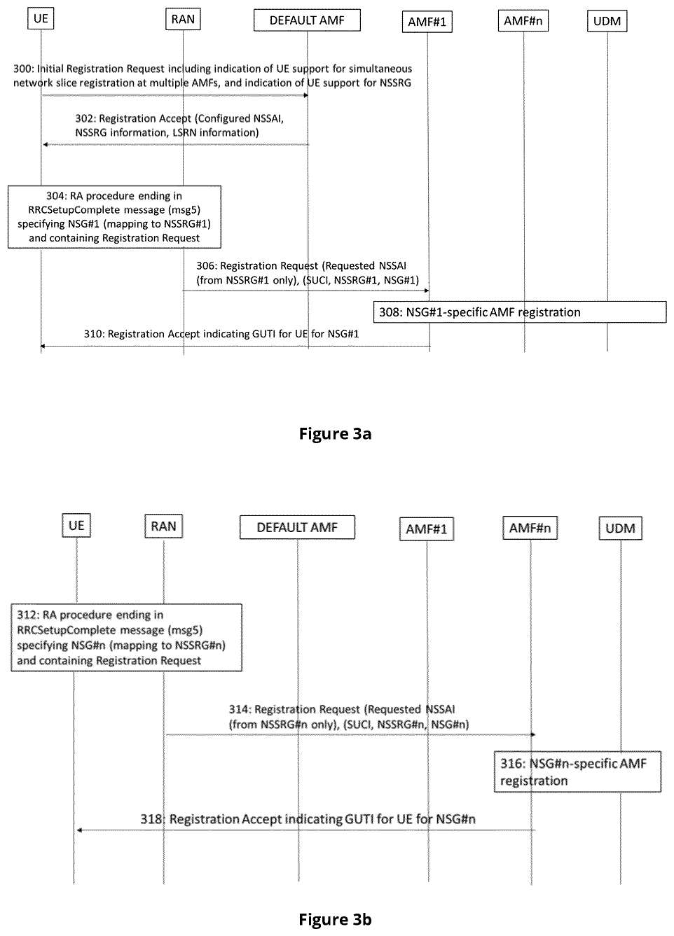

FIGS. 3a and 3b together show a representation of operations at UE 100, RAN 200, a plurality of AMF instances 204 and the UDM 206 according to a first example embodiment.

UE 100 follows a random access (RA) procedure to establish an initial RRC connection with the 5G RAN 200. Establishment of the initial RRC connection is completed with UE 100 sending a RRC connection setup complete message (msg5 of the RA procedure) carrying a Registration Request message (OPERATION 300). The Registration Request message indicates that UE 100 supports parallel registration to a plurality of network slices at multiple AMF instances 204 (which network slices are referred to here as disjointed network slices or disjointed network slice groups); and also indicates that UE 100 supports parallel registration restriction to a plurality of network slices at a single AMF instance 204 (hereafter referred to as NSSRG support) defined in 3GPP TS 23.501 clause 5.15. The RRC connection setup complete message does not include any globally unique temporary identifier (GUTI) for UE 100.

In the absence of any GUTI (or network slice (group) identifier) in the RRC connection setup complete message, the 5G RAN 200 forwards the Registration Request message (carried by the RRC connection setup complete message) to a default AMF instance 204.

The Registration Accept message sent by the default AMF 204 to UE 100 via 5G RAN 200 includes information about network slices (or groups of network slices) registrable in parallel via different AMFs.

The Registration Accept message indicates the networks slices configured for the public land mobile network (PLMN) for which the 5G system is deployed. This indication may take the form of a Configured NSSAI indication. An NSSAI indicates a set of network slices.

The Registration Accept message also includes information about which network slices are registrable in parallel via the same AMF instance 204. Groups of network slices which are registrable in parallel via a common AMF instance 204 are referred to here as network slice simultaneous registration groups (NSSRGs).

The Registration Accept message also includes information about which NNSRGs are registrable in parallel via different AMF instances 204. This information may take the form of a list of NSSRGs that are registrable in parallel via different AMF instances 204; and this list is referred to here as a list of simultaneously registrable NSSRGs (LSRN). The LSRN maps each of the simultaneously registrable NSSRGs to a network slice group identifier (NSG #).

UE 100 determines to register to one more network slices that the LSRN and LNSG indicate are in separate network slice groups (NSGs) and require parallel registrations via different AMF instances 204. For example, UE 100 determines to register to one or more network slices (identified by one or more S-NSSAIs) in NSG #1, and also to one or more network slices (identified by one or more S-NSSAIs) in NSG #n.

This determination is done via NNSRG identifiers NSSRG #1 and NSSRG #n, which map to NSG identifiers NSG #1 and NSG #n. UE 100 determines the NSSRGs including the network slices to which UE 100 determines to register, and determines the NSG identifier values for these network slices using the NSSRG to-NSG mapping provided by the LNSG.

UE 100 follows a new RA procedure (independent of the RA procedure used to establish the initial RRC connection) to establish a further RRC connection for registration to one or more network slices in NSG #1. The establishment of this further RRC connection is completed by UE 100 transmitting a RRC connection setup complete message (msg5) indicating NSG #1 (mapping to NSSRG #1), and carrying a Registration Request message (OPERATION 304). This RRC connection setup complete message (msg5) does not include a GUTI.

Based on the NSG identifier NSG #1 indicated in the RRC connection setup complete message, the 5G RAN forwards the Registration Request message (carried by the RRC connection setup complete message) to the AMF instance (AMF #1) associated with NSG #1 (OPERATION 306).

The Registration Request message sent from UE 100 to AMF #1 via 5G RAN 100 indicates one or more network slices (Requested NSSAI) all belonging to NSSRG #1. The Registration Request message also includes: a Subscription Concealed Identifier (SUCI) value for UE 100; the NSSRG value for the NSSRG to which the one or more network slices belong; and the NSG value corresponding to the NSSRG value.

AMF #1 registers itself with UDM function 306 as the currently serving AMF instance for UE 100 for network slices in NSG #1 (OPERATION 308). This registration of AMF #1 at UDM function 306 is specific to network slices in NSG #1. As discussed below, other AMFs may register themselves at UDM function 206 as the currently serving AMF instances for UE 100 for other network slices in other NSGs. AMF #1 provides the UDM function with the NSG value (NSG #1) for the group of network slices served by AMF #1. With reference to FIG. 6, the UDM function 206 may store a plurality of Global Public Subscription Identity (GPSI) based values for the same UE 100 for different NSGs. Each GPSI based value for the UE comprises a combination of a GPSI root value (GPSI #0 in the example of FIG. 6) for the UE 100 and a NSG suffix value. In other words, the NSG value is used to colour the GPSI value registered at UDM function 206 for UE 100 for the NSG. External applications providing mobile-terminated (MT) services for one or more network slices in a NSG use the composite GPSI value to query the UDM function 206. For example, external applications providing mobile-terminated (MT) services for one or more network slices in NSG #1 use the composite GPSI value GPSI #0-NSG #1 to query the UDM function 206 about which AMF instance currently serves UE 100 for NSG #1 (NNSRG #1).

AMF #1 sends a Registration Accept message to UE 100 via 5G RAN 200 (OPERATION 310). The Registration Accept message indicates a GUTI specific to NSG #1 (mapping to NNSRG #1).

While retaining the registration to one or more network slices in NSSRG #1 (NSG #1), UE 100 repeats the procedure for achieving a parallel registration to one or more network slices in NNSRG #n (mapped to NSG #n) (OPERATIONS 312, 314, 316 and 318). In these subsequent operations, NNSRG #n and NSG #n are used instead of NNRSG #1 and NSG #1; and AMF #n is the AMF instance to which the Registration Request message is forwarded, instead of AMF #1. The procedure of registering UE 100 to one or more network slices in NSSRG #n (NSG #n) completes with AMF #n sending to UE 100 an registration accept message including a GUTI specific to NSG #n.

UE 100 may later determine to register to one or more other network slices in NSSRG #1 (NSG #1). In any (and all) subsequent registrations by UE 100 to one or other network slices in NSSRG #1, UE 100 uses the NSG #1 specific GUTI that it already received in the registration accept message from AMF #1. UE 100 includes this NSG #1-specific GUTI in any RRC connection setup complete message completing the procedure to establish any RRC connection for registration to the one or more other network slices in NSSRG #1, and also in the Registration Request message contained in the RRC connection setup complete message (together with NSG #1 mapping to NSSRG #1).

Similarly, UE 100 may later determine to register to one or more other network slices in NSSRG #n (NSG #n). In any (and all) subsequent registrations by UE 100 to one or other network slices in NSSRG #n, UE 100 uses the NSG #n-specific GUTI that it already received in the registration accept message from AMF #n. UE 100 includes this NSG #n-specific GUTI in any RRC connection setup complete message completing the procedure to establish any RRC connection for registration to the one or more other network slices in NSSRG #n, and also in the Registration Request message contained in the RRC connection setup complete message (together with NSG #n mapping to NSSRG #n).

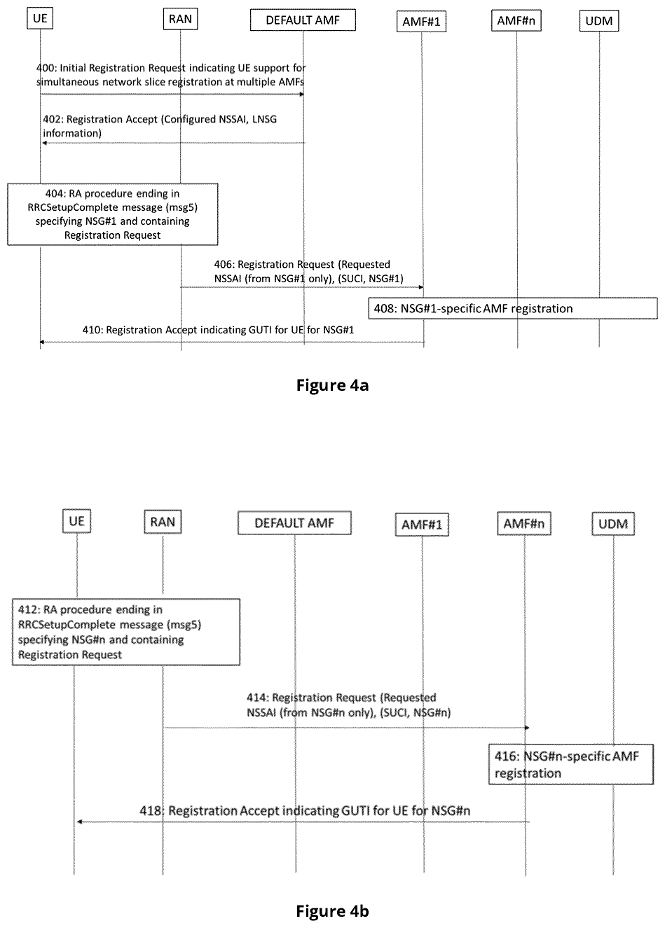

A second example embodiment shown in FIGS. 4a and 4b is the same as the first example embodiment shown in FIGS. 3a and 3b, except that UE 100 is provided with information about a plurality of network slices registrable in parallel via a plurality of AMF instances without reference to NSSRG. The initial Registration Request message (OPERATION 400) does not include the indication that UE supports parallel registration restriction for a plurality of network slices via a single AMF instance 204. The information (included in the Registration Accept message (OPERATION 402) from the default AMF) about network slices registrable in parallel via a plurality of AMFs includes a list (LNSG-List of Network Slices Groups) directly mapping sets of network slices (identified by S-NSSAIs) to one or more network slice group (NSG) identifiers used in the serving PLMN. There may be at least one network slice (identified by S-NSSAI) that the LNSG maps to more than one NSG; and a decision at UE 100 about which of the possible NSGs to select for that S-NSSAI may be based on one or more best fit criteria.

The subsequent operations shown in FIGS. 4a and 4b (OPERATIONS 404 to 418) are the same as OPERATIONS 304 to 318 in FIGS. 3a and 3b, except that NSG values are the used without reference to NSSRG values.

UE 100 may later determine to register to one or more other network slices in NSG #1. In any (and all) subsequent registrations by UE 100 to one or other network slices in NSG #1, UE 100 uses the NSG #1 specific GUTI that it already received in the registration accept message from AMF #1. UE 100 includes this NSG #1-specific GUTI in any RRC connection setup complete message completing the procedure to establish any RRC connection for registration to the one or more other network slices in NSG #1, and also in the Registration Request message contained in the RRC connection setup complete message (together with NSG #1 mapping to NSG #1).

Similarly, UE 100 may later determine to register to one or more other network slices in NSG #n. In any (and all) subsequent registrations by UE 100 to one or other network slices in NSG #n, UE 100 uses the NSG #n-specific GUTI that it already received in the registration accept message from AMF #n. UE 100 includes this NSG #n-specific GUTI in any RRC connection setup complete message completing the procedure to establish any RRC connection for registration to the one or more other network slices in NSG #n, and also in the Registration Request message contained in the RRC connection setup complete message (together with NSG #n mapping to NSG #n).

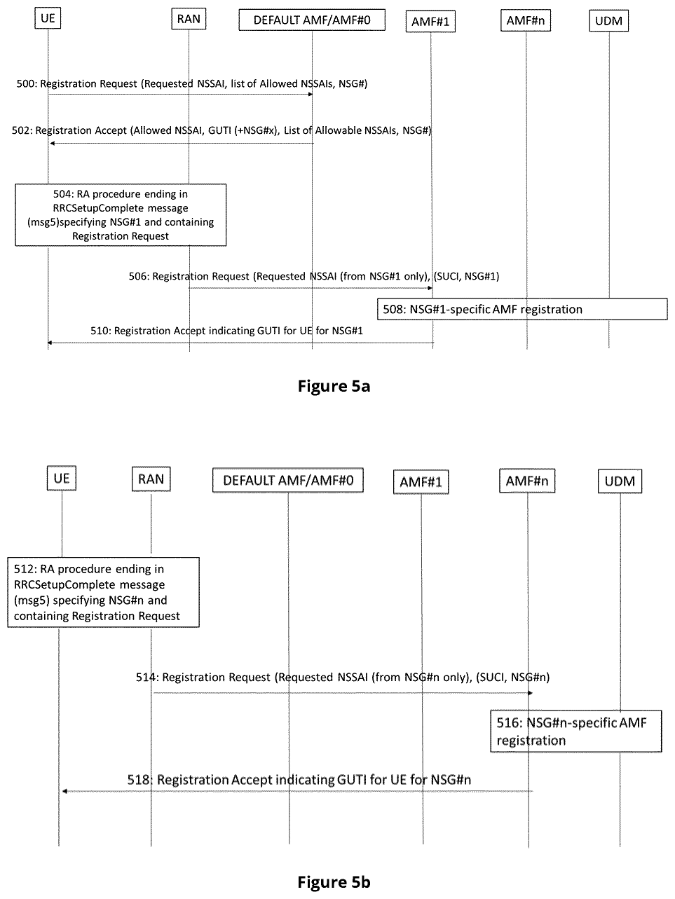

In the first and second example embodiments described above, the indication that UE 100 supports parallel registrations to multiple network slices at multiple AMFs is included in an initial Registration Request message (before UE100 has registered to any network slice, and before UE 100 has information about the configured NSSAI for the PLMN). According to a third example embodiment shown in FIGS. 5a and 5b, the indication is included in a Registration Request message for a new registration to one or more network slices, after UE 100 is already registered to one or more network slices. This indication is included in a registration request message that additionally indicates: a requested NSSAI comprising network slices (S-NSSAIs) for which UE 100 does not know the NSG identifiers; a list of Allowed NSSAIs (wherein each allowed NSSAI includes one or more network slices to which UE 100 is already registered via a respective AMF), and the respective NSG identifiers for each Allowed NSSAI; and a GUTI for UE 100 for one of the NSGs including one or more network slices to which UE 100 is already registered. The inclusion of this GUTI in the initial Registration Request message assists in UE identity validation for UE 100.

Based on the GUTI included in the RRC connection setup complete message carrying the Registration Request message (OPERATION 500), the 5G RAN selects an AMF instance to which to forward the Registration Request message (also referred to as the default AMF in this 3rd example embodiment).

According to this third example embodiment, the Registration Accept message from a AMF instance (AMF #0) associated with one or more of the requested network slices may indicate a first allowed NSSAI mapped to NSG #0 not indicated in the Registration Request message from UE 100 (i.e. an NSG including no network slice to which UE 100 was already registered). In other words, the AMF instance (AMF #0) that sends the Registration Accept message may not be associated with any of the network slices to which UE 100 was already registered.

The Registration Accept message may also indicate one or more allowable NSSAIs (wherein each allowable NSSAI includes one or more network slices registrable in parallel to the network slices to which UE 100 is already registered), and the NSG identifier values for the allowable NSSAIs. Each of these allowable NSSAIs may or may not have a NSG identifier value matching an NSG identifier value included by UE 100 in the Registration Request message. The Registration Accept message from AMF #0 also includes a GUTI specific to NSG #0.

UE 100 may continue to determine to register to one or more network slices in one or more of the allowable NSSAIs. In this example, UE 100 determines to register to one or more network slices which the information in the Registration Accept message (from AMF #0) indicates belong to NSG #1 and to one or more network slices which the information in the Registration Accept message (from AMF #0) indicates belong to NSG #n. The operations thereafter (OPERATIONS 504 to 518) are the same as OPERATIONS 404 to 418 of the second example embodiment shown in FIGS. 4a and 4b.

UE 100 may later determine to register one or more network slices in NSG #0 (associated with AMF #0). In any (and all) subsequent registrations by UE 100 to one or other network slices in NSG #0, UE 100 uses the NSG #0-specific GUTI that it received in the Registration Accept message from AMF #0. UE 100 includes this NSG #0-specific GUTI in any RRC connection setup complete message completing any procedure to establish an RRC connection for registration to the one or more other network slices in NSG #0, and in the Registration Request message contained in the RRC connection setup complete message (together with the identifier for NSG #0).

Similarly, UE 100 may also later determine to register to one or more other network slices in NSG #1. In any (and all) subsequent registrations by UE 100 to one or other network slices in NSG #1, UE 100 uses the NSG #1-specific GUTI that it received in the registration accept message from AMF #1. UE 100 includes this NSG #1-specific GUTI in any RRC connection setup complete message completing the procedure to establish any RRC connection for registration to the one or more other network slices in NSG #1, and also in the Registration Request message contained in the RRC connection setup complete message (together with NSG #1 mapping to NSG #1).

Similarly, UE 100 may later determine to register to one or more other network slices in NSG #n. In any (and all) subsequent registrations by UE 100 to one or other network slices in NSG #n, UE 100 uses the NSG #n-specific GUTI that it received in the registration accept message from AMF #n. UE 100 includes this NSG #n-specific GUTI in any RRC connection setup complete message completing the procedure to establish any RRC connection for registration to the one or more other network slices in NSG #n, and also in the Registration Request message contained in the RRC connection setup complete message (together with NSG #n mapping to NSG #n).

In all the embodiments described above, the NSG # is included in the RRC message #5 (RRC CONNECTION SETUP COMPLETE) to cause the included NAS registration message to be routed to the right AMFs serving the NSG #. According to one example variation, the NSG # is not included in the RRC part of the RRC Connection SetUp complete message (only in the Register Request message carried by the RRC Connection SetUp Complete message); and the 5G RAN 200 forwards the Register Request message to a default AMF instance. The default AMF instance selects an AMF instance to which to forward the Register Request message based on the NSG # included in the Register Request message. This redirection of messages from the default AMF instance to another AMF instance may follow the procedure specified in TS 23.502 clause 4.2.2.2.3. with a modification to base the redirection decision on the NSG # value provided in the Registration Request message. Furthermore, the 5G system operator may control whether UE 100 includes the NSG # in the RRC part of the RRC CONNECTION SETUP COMPLETE message. This control may, for example, be based on information the AMF sends to the UE (such as the Access Stratum Connection Establishment NSSAI Inclusion Mode defined in TS 23.501).

In all the above-described embodiments, when UE 100 is requesting registration to one or more network slices in a NSG including no network slice to which UE 100 is already registered, UE 100 may include in the registration request message a GUTI specific to a NSG including one or more network slices to which UE 100 is already registered (e.g. this is explicitly indicated in the registration message to be associated to the specific NSG #). This may assist validation of UE identity and the retrieval of subscriber data for UE 100. Including the GUTI for a different NSG does not cause context transfer unless this is indicated (e.g. when a new AMF instance is selected to serve a broader set of network slices (identified by S-NSSAIs), or a smaller set of network slices (identified by S-NSSAIs).

As a transitory measure for UEs not supporting parallel registration to a plurality of network slices via different AMF instances (i.e. UEs only supporting parallel registration to a plurality of network slices via a single AMF instance), there may be a special and limited option for those non-supporting UEs (only) to instead register in parallel to the same plurality of network slices (identified by S-NSSAIs) via a single AMF instance. This option may not be provided for some network slices for which there are strict isolation requirements (including strict isolation requirements in relation to access management functionality). For such network slices, the non-supporting UE would be limited to ending a registration to one network slice associated with one AMF instance before registering to another network slice associated with another AMF instance.

The above-described embodiments facilitate the simultaneous registration by a UE to a plurality of isolated network slices while retaining a high degree of isolation between the network slices (such as a high degree of isolation between the access management functionality for the network slices).

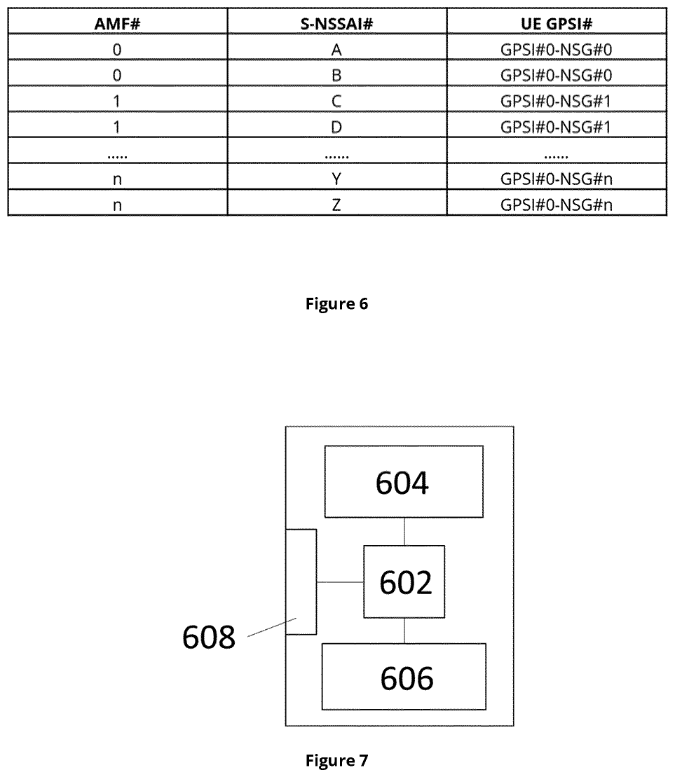

FIG. 7 illustrates an example of an apparatus for implementing the operations of UE 100 or a RAN node 200 in the embodiments described above. The apparatus may comprise at least one processor 602 coupled to one or more interfaces 608. For the example of UE 100, the one or more interfaces 608 may be to e.g. other equipment for which the UE functionality 100 provides radio communications. For the example of a RAN node 20, the one or more interfaces 608 may be to e.g. core network nodes such as those implementing the AMF instances 204, and other RAN nodes. The at least one processor 602 is also coupled to a radio unit 604 including one or more antennas etc. for making and receiving radio transmissions. The at least one processor 602 may also be coupled to at least one memory 606. The at least one processor 602 may be configured to execute an appropriate software code to perform the operations described above. The software code may be stored in the memory 606.

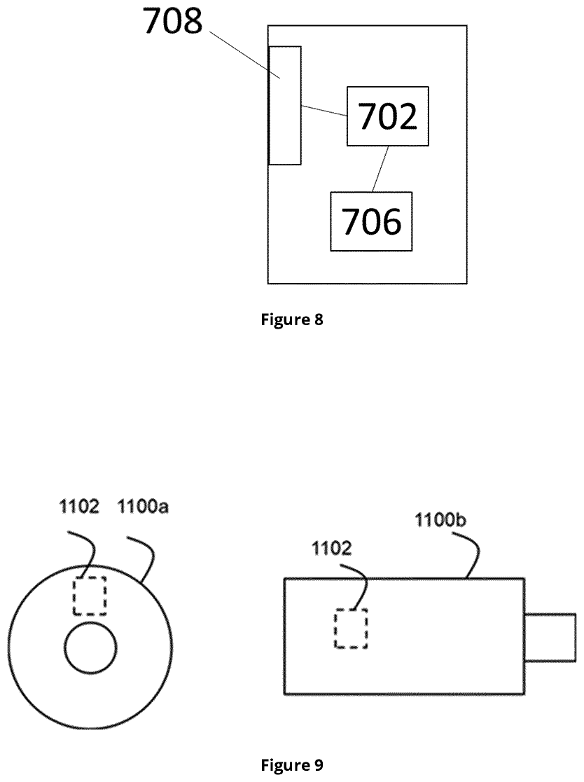

FIG. 8 illustrates an example of an apparatus for implementing the operations of a node implementing an AMF instance 204 or a node implementing the UDM function 206 in the embodiments described above. The apparatus may comprise at least one processor 702 coupled to one or more interfaces 708. For the example of a node implementing an AMF instance 204, the one or more interfaces 708 may be for communication with RAN nodes 200 and for communication with the node implementing the UDM function 206. For the example of a node implementing UDM function 206, the one or more interfaces 708 may e.g. be for communication with the nodes implementing the AMF instances 204. The at least one processor 702 may also be coupled to at least one memory 706. The at least one processor 702 may be configured to execute an appropriate software code to perform the operations described above. The software code may be stored in the memory 706.

FIG. 9 shows a schematic representation of non-volatile memory media 1100a (e.g. computer disc (CD) or digital versatile disc (DVD)) and 1100b (e.g. universal serial bus (USB) memory stick) storing instructions and/or parameters 1102 which when executed by a processor allow the processor to perform one or more of the steps of the methods described previously.

It is to be noted that embodiments of the present invention may be implemented as circuitry, in software, hardware, application logic or a combination of software, hardware and application logic. In an example embodiment, the application logic, software or an instruction set is maintained on any one of various conventional computer-readable media. In the context of this document, a “computer-readable medium” may be any media or means that can contain, store, communicate, propagate or transport the instructions for use by or in connection with an instruction execution system, apparatus, or device, such as the base stations or user equipment of the above-described embodiments.

As used in this application, the term “circuitry” refers to all of the following: (a) hardware-only circuit implementations (such as implementations in only analog and/or digital circuitry) and (b) to combinations of circuits and software (and/or firmware), such as (as applicable): (i) to a combination of processor(s) or (ii) to portions of processor(s)/software (including digital signal processor(s)), software, and memory(ies) that work together to cause an apparatus, such as the user equipment or base stations of the above-described embodiments, to perform various functions) and (c) to circuits, such as a microprocessor(s) or a portion of a microprocessor(s), that require software or firmware for operation, even if the software or firmware is not physically present. This definition of ‘circuitry’ applies to all uses of this term in this application, including in any claims. As a further example, as used in this application, the term “circuitry” would also cover an implementation of merely a processor (or multiple processors) or portion of a processor and its (or their) accompanying software and/or firmware. The term “circuitry” would also cover, for example and if applicable to the particular claim element, a baseband integrated circuit or applications processor integrated circuit for a mobile phone or a similar integrated circuit in server, a cellular network device, or other network device.

The described features, advantages, and characteristics of the invention can be combined in any suitable manner in one or more embodiments. One skilled in the relevant art will recognize that the invention can be practiced without one or more of the specific features or advantages of a particular embodiment. In other instances, additional features and advantages can be recognized in certain embodiments that may not be present in all embodiments of the invention. One having ordinary skill in the art will readily understand that the invention as discussed above may be practiced with steps in a different order, and/or with hardware elements in configurations which are different than those which are disclosed. Therefore, although the invention has been described based upon these preferred embodiments, it would be apparent to those of skill in the art that certain modifications, variations, and alternative constructions would be apparent, while remaining within the spirit and scope of the invention.

1. A method comprising:
receiving, at a user equipment, parallel registration information indicating at least:
one or more first network slices associated with a first access management function instance; and
one or more second network slices associated with a second access management function instance and registrable in parallel with the one or more first network slices.

2. The method according to claim 1, further comprising:
transmitting, from the user equipment, an indication of support at the user equipment for parallel registration to a plurality of network slices associated with a plurality of access management function instances;
wherein the receiving the parallel registration information is after the transmitting.

3. The method according to claim 2, further comprising:
including the indication in a registration request message inside a radio resource control connection setup complete message of a procedure to set up a first radio resource control connection; and
receiving the parallel registration information in a registration accept message from an access management function instance in response to the registration request message.

4. The method according to claim 3, wherein the parallel registration information comprises:
at least a first network slice group value for the first one or more network slices; and
at least a second network slice group value for the one or more second network slices.

5. The method according to claim 4, further comprising:
establishing a second radio resource control connection in parallel with the first radio resource control connection, wherein the establishing the second radio resource control connection comprises:
transmitting, inside a radio resource control connection setup complete message specifying the first network slice group value, a registration request message specifying one or more network slices mapped to the first network slice group value.

6. The method according to claim 5, further comprising:
establishing a third radio resource control connection in parallel with at least the second radio resource control connection, wherein the establishing the third radio resource control connection comprises:
transmitting, inside a radio resource control connection setup complete message specifying the second network slice group value, a radio resource control connection setup complete message including a registration request message specifying one or more network slices mapped to the second network slice group value.

7. The method according to claim 1, wherein the parallel registration information indicates at least:
a first group of network slices associated with a first access management function instance and registrable in parallel with each other; and
a second group of network slices associated with a second access management function instance, wherein the network slices of the second group are registrable in parallel with each other and in parallel with any network slice of the first group.

8. The method according to claim 1, wherein the parallel registration information indicates the at least one or more first network slices and the one or more second network slices, without reference to groups of network slices registrable in parallel with each other via a common access management function instance.

9.-46. (canceled)

47. An apparatus comprising:
at least one processor; and
at least one memory storing instructions that, when executed by the at least one processor, cause the apparatus to perform:
receiving parallel registration information indicating at least:
one or more first network slices associated with a first access management function instance; and
one or more second network slices associated with a second access management function instance and registrable in parallel with the one or more first network slices.

48. The apparatus according to claim 47, wherein the instructions, when executed by the at least one processor, further cause the apparatus to perform:
transmitting an indication of support at a user equipment for parallel registration to a plurality of network slices associated with a plurality of access management function instances;
wherein the receiving the parallel registration information is after the transmitting.

49. The apparatus according to claim 48, wherein the instructions, when executed by the at least one processor, further cause the apparatus to perform:
including the indication in a registration request message inside a radio resource control connection setup complete message of a procedure to set up a first radio resource control connection; and
receiving the parallel registration information in a registration accept message from an access management function instance in response to the registration request message.

50. The apparatus according to claim 49, wherein the parallel registration information comprises:
at least a first network slice group value for the first one or more network slices; and
at least a second network slice group value for the one or more second network slices.

51. The apparatus according to claim 50, wherein the instructions, when executed by the at least one processor, further cause the apparatus to perform:
establishing a second radio resource control connection in parallel with the first radio resource control connection, wherein the establishing the second radio resource control connection comprises:
transmitting, inside a radio resource control connection setup complete message specifying the first network slice group value, a registration request message specifying one or more network slices mapped to the first network slice group value.

52. The apparatus according to claim 51 wherein the instructions, when executed by the at least one processor, further cause the apparatus to perform:
establishing a third radio resource control connection in parallel with at least the second radio resource control connection, wherein the establishing the third radio resource control connection comprises:
transmitting, inside a radio resource control connection setup complete message specifying the second network slice group value, a radio resource control connection setup complete message including a registration request message specifying one or more network slices mapped to the second network slice group value.

53. The apparatus according to claim 47, wherein the parallel registration information indicates at least:
a first group of network slices associated with a first access management function instance and registrable in parallel with each other; and
a second group of network slices associated with a second access management function instance, wherein the network slices of the second group are registrable in parallel with each other and in parallel with any network slice of the first group.

54. The apparatus according to claim 47, wherein the parallel registration information indicates the at least one or more first network slices and the one or more second network slices, without reference to groups of network slices registrable in parallel with each other via a common access management function instance.

55. The apparatus according to claim 49, wherein the registration request message comprises at least: an indication of one or more requested network slices.

56. The apparatus according to claim 55, wherein the registration request message further comprises at least:
an indication of one or more network slices to which the user equipment is already registered, and one or more network slice group values for the one or more network slices to which the user equipment is already registered.

57. The apparatus according to claim 56, wherein the parallel registration information comprises an indication of one or more network slices registrable in parallel to the one or more network slices to which the user equipment is already registered.

58.-73. (canceled)

74. A computer readable medium comprising program instructions stored thereon which, when executed by at least one processor of an apparatus, cause the apparatus to perform:
receiving parallel registration information indicating at least:
one or more first network slices associated with a first access management function instance; and
one or more second network slices associated with a second access management function instance and registrable in parallel with the one or more first network slices.

75.-85. (canceled)
